(19) United States
(12) Patent Application Publication
(10) Pub. No.: US 2026/0324601 A1
(43) Pub. Date: Oct. 22, 2026

(54) AUTOMATIC MEASURING WICKET

(71) Applicant: George Wiles, Farmington, MO (US)

(72) Inventor: George Wiles, Farmington, MO (US)

(21) Appl. No.: 19/645,887

(22) Filed: Apr. 13, 2026

Related U.S. Application Data
(60) Provisional application No. 63/789,737, filed on Apr. 16, 2025.

(51) Int. Cl. A01K 29/00

(52) U.S. Cl. CPC A01K 29/002

(57) ABSTRACT

An automatic measuring wicket for automatically measuring various heights of an animal, such as a dog, is provided. The automatic measuring wicket can be placed over any portion of the animal, such as the withers, where a measurement can be automatically taken through the user overcoming a spring-bias through a downward application of force on a crossbar assembly that requires almost no attention to detail. The crossbar assembly contacts a desired measuring point of the animal up contacting that measuring point, where measurement reading of that measuring points are automatically revealed along an upper portion of the automatic measuring wicket. Additionally, the automatic measuring wicket can be moved along portions of the animal, such as from the withers to the hind quarters, where measurements can be taken continuously and automatically.

### CROSS REFERENCE TO RELATED APPLICATION

This application claims the benefit of priority of U.S. provisional application number 63/789,737, filed Apr. 16, 2025, the contents of which are herein incorporated by reference.

### BACKGROUND OF THE SUBJECT DISCLOSURE

The subject disclosure relates to measuring devices, and more particularly, to an automatic measuring wicket configured to measure animal standards.

Dog shows allow purebred dogs to be judged based on their conformation to breed standards, such as size, coat type, and body structure. Dogs are penalized for non-conformation to breed standards. For example, American Kennel Club breed standards for Gold Retrievers are 23-24 inches in height for males, and 21.5-22.5 inches in height for females, where dogs that are up to 1 inch above or below the standard are penalized, and dogs more than 1 inch above or below are disqualified. Traditionally, a measuring wicket is placed at the withers of the dog to measure height, however, the traditional wicket requires a user to adjust the height.

As can be seen, there is a need for a measuring wicket configured to automatically adjust to animal height to quickly and accurately measure the height of an animal.

### SUMMARY OF THE SUBJECT DISCLOSURE

In one aspect of the present subject disclosure, a measuring wicket includes the following: at least one leg portion, each leg portion having a proximal end configured to engage the supporting surface; a crossbar assembly movable relative to the at least one leg portion between a resting point and a measuring point relative to the supporting surface; a device that stores energy when compressed coupled to each leg portion and operatively associated with the crossbar assembly so as to bias the crossbar assembly toward the resting point relative to the supporting surface; and measuring indicia provided along the leg portion so that a distance between the crossbar assembly and said proximal end is continuously visible.

In another aspect of the present subject disclosure, the measuring wicket may include wherein the crossbar assembly has a slidable relationship with the at least one leg portion, wherein the crossbar assembly has at least one connector for each leg portion, wherein each connector slides over the leg portion, wherein the at least one leg portion is two leg portions, wherein the crossbar assembly spans between the two leg portions, wherein the crossbar assembly comprises an upper crossbar and a lower crossbar, wherein the lower crossbar contacts the measuring point, wherein said proximal end of each leg portion has a footer that contacts the supporting surface; further including a spring stop disposed within each leg portion, wherein each spring stop configured to limit compression of said device, and wherein each leg portion is limited in travel by the footer at the proximal end thereof and by an end cap at a distal end thereof.

In yet another aspect of the present subject disclosure, a method of continuously measuring two or more measuring points of an animal, the method includes the following steps: placing the above mentioned measuring wicket over the animal until a proximal end of each leg portion contacts a supporting surface of the animal; urging the crossbar assembly toward the animal until it contacts a first measuring point of the two or more measuring points; moving the animal out of plane relative to said measuring wicket until the crossbar assembly contacts a second measuring point of the two or more measuring points while maintaining said urging of the crossbar assembly so that said distances, associated with the first and second measuring points, between the crossbar assembly and said proximal end measuring indicia are visible.

These and other features, aspects and advantages of the present subject disclosure will become better understood with reference to the following drawings, description and claims.

### BRIEF DESCRIPTION OF THE DRAWINGS

FIG. 1 is a perspective view of an embodiment of an automatic measuring wicket 100 shown in use, according to aspects of the subject disclosure.

FIG. 2 is a perspective view of an embodiment of the automatic measuring wicket 100, according to aspects of the subject disclosure.

FIG. 3 is an exploded perspective view of an embodiment of an automatic measuring wicket 100, according to aspects of the subject disclosure.

FIG. 4 is a sectional view of an embodiment of an automatic measuring wicket taken along line 4-4 in FIG. 2, according to aspects of the subject disclosure.

### DETAILED DESCRIPTION OF THE SUBJECT DISCLOSURE

The following detailed description is of the best currently contemplated modes of carrying out exemplary embodiments of the subject disclosure. The description is not to be taken in a limiting sense but is made merely for the purpose of illustrating the general principles of the subject disclosure, since the scope of the subject disclosure is best defined by the appended claims.

Broadly, an embodiment of the subject disclosure provides a mechanism for automatically measuring the height of an animal, such as a dog, for compliance with breed standards. The mechanism of the subject disclosure can be placed over any portion of the animal, such as the withers, where a measurement can be automatically taken. Additionally, the mechanism of the subject disclosure can be moved along portions of the animal, such as from the withers to the hind quarters, where measurements can be taken continuously and automatically.

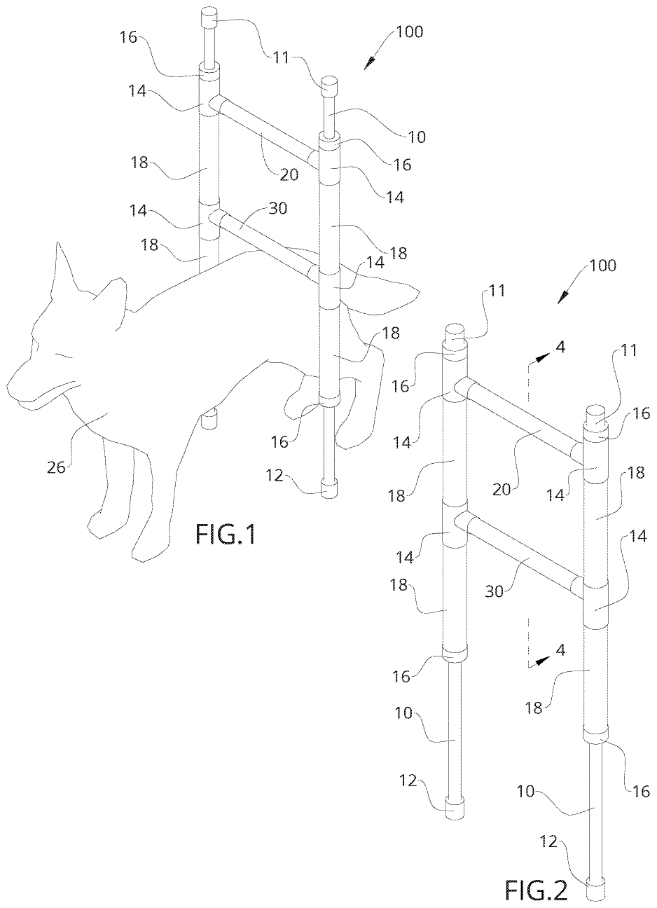

Referring now to FIGS. 1-4, elements of an embodiment of an automatic measuring wicket 100 of the subject disclosure are illustrated. FIG. 1 illustrates an embodiment of an automatic measuring wicket show in use. A user can take at least one measurement of an animal 26, such as a dog, utilizing the automatic measuring wicket of the subject disclosure. In embodiments, each footer 12 may be placed in contact with a surface from which a measurement is to be taken, such as the ground when the automatic measuring wicket is positioned over the animal 26 at a measuring point, such as the withers, hindquarters, or other animal portions.

To measure, a user can press down on upper crossbar 20 until lower crossbar 30 encounters animal 26 at the measuring point. Once lower crossbar 30 encounters animal 26 at the measuring point the user can read off a measurement indicated on measuring scale pipes 10. In embodiments, once upper crossbar 20 is released or not subject to user force it can return to a resting position (as shown in FIG. 2). In embodiments, a series of discrete, or continuous, measurements can be made of the animal 26. Continuous measurements can be made by the user pressing down on upper crossbar 20 such that the lower crossbar 30 contacts animal 26 while animal is moving through the wicket. Discrete measurements can be made by repeatedly moving the wicket, or the animal 26, and once a measuring point is desired, urging upper crossbar 20 downward until lower crossbar 30 contacts animal 26. Advantageously, the wicket of the subject disclosure provides an automated means to measure an animal that is quick and efficient.

The upper crossbar 20 and the lower crossbar 30 may be in mechanical communication with each other, where moving one moves the other—i.e., the crossbars 20 and 30 may be rigidly connected relative to each other.

The automatic measuring wicket can be made from a plurality of components and configured to take at least one measurement of an animal. In embodiments, the plurality of components can include a plurality of measuring pipes 10, a plurality of end caps 11, a plurality of connectors 14, a plurality of adaptors 16, a plurality of pipes 18, and a plurality of crossbars 20. In embodiments, a subset of the plurality of components can be assembled to form a plurality of legs which can be connected via the plurality of crossbars 20.

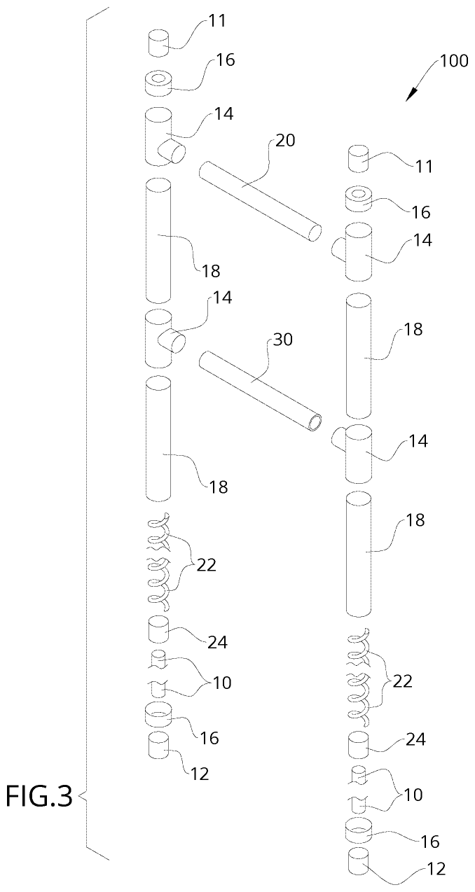

FIG. 3 illustrates an exploded view of an embodiment of an automatic measuring wicket 100. In embodiments, each of the plurality of legs of the automatic measuring wicket 100 can have a housing formed from a subset of the plurality of connectors 14, and a subset of the plurality of pipes 18. In embodiments, each housing can include a pair of connectors 14 interleavably coupled to a pair of pipes 18, as illustrated in FIG. 3. In embodiments, an upper connecter 14 of each leg can have an adapter coupled thereto, as illustrated in FIG. 3. In embodiments, each leg can include a spring 22 disposed within its housing and a measuring pipe 10 disposed inside of the coil of spring 22. Furthermore, each housing can include a spring stop 24 disposed on the interior of the housing proximate to a lower portion thereof and configured to prevent displacement of spring 22. In embodiments, spring stop 24 is tubular such that measuring pipe 10 passed through an interior thereof. Spring stop 24 and spring 22 of each housing can be held on an interior of housing 16 by an adaptor 16 disposed at each end of each housing. Additionally, each measuring pipe 10 can be travel restricted by a footer 12 and an end cap 11 disposed on each end thereof, as illustrated in FIG. 3. Finally, each leg can be connected to the other by connecting a subset of the plurality of connectors 14 to one of the crossbars 20, as illustrated in FIG. 3.

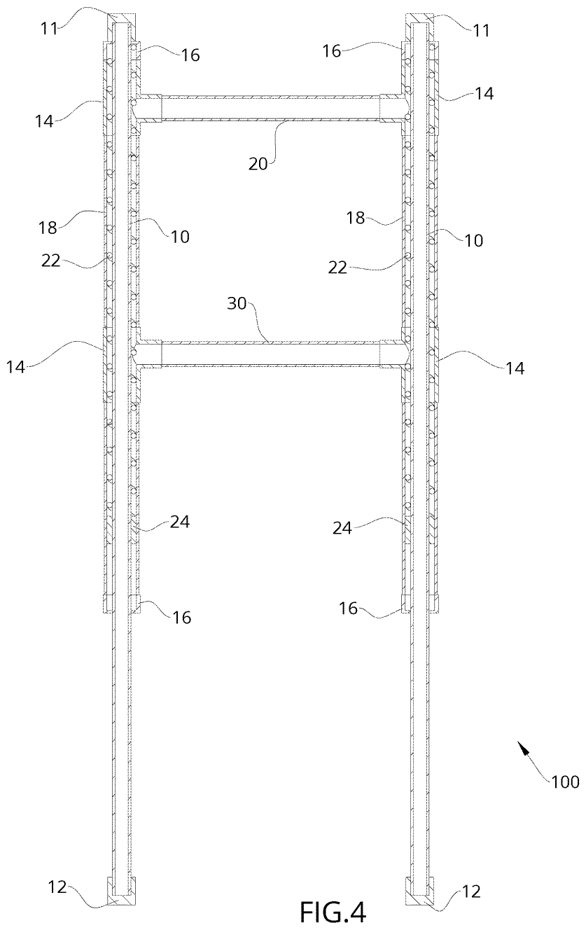

FIG. 4 illustrates a sectional view of the automatic measuring wicket 100. Specifically, internal components configured to provide automatic measuring are illustrated. In embodiments, each leg of the automatic measuring wicket has a spring 22 disposed inside pairs of interleavably coupled connectors 14 and pipes 18. In embodiments, measuring pipe 10 can be disposed inside the inner diameter of spring 22 thereby forming an actuatable measuring pipe. Spring 22 may be held inside each leg portion of the automatic measuring wicket 100 by a pair of adapters 16 each disposed at an end of the pairs of interleavably coupled connectors 14 and pipes 18. Spring stop 24 is disposed within each leg of the automatic measuring wicket 100 can configured to limit compression of spring 22. Additionally, each leg is limited in travel by a footer 12 and end cap 11 pair disposed at each end of measuring pipe 10.

It should be understood that the connectors 14 and the pipers 18 need not be interleavable for the subject disclosure to function and that other types of coupling and operative association between the connectors 14 and pipes 18 are contemplated by the subject disclosure, even if they are not shown in the Figures.

Referring further to operational aspects of the automatic measuring wicket 100, with reference to FIG. 4. Footer 12 and end cap 11 provide the limit of travel for each leg portion wherein in a resting position end cap 11 disposed on an upper end of measuring pipe 10 prevents further expansion of spring 22. As a user applies force to an upper crossbar 20 springs 22 compress as upper adaptors 16 provide a downward force. Springs 22 compresses until lower crossbar 30 contacts a portion of an animal 26. Once contact is made by lower crossbar 30 the measuring indicia is displayed on each of measuring pipes 10. In embodiments, indicia can be a plurality of numbers and or markings arranged to provide continuous measurements, like a measuring tape, and can indicate a total height from the supporting surface of the footers 12 to the portion of lower crossbar 30 contacting the animal 26.

Spring stops 24 provide resistance such that when a user reduces, or ceases to apply force, springs 22 can return to a resting position. In other words, the springs 22 bias the automatic measuring wicket 100 in the resting position, thereby at the initiation of measuring an animal 26, the lower crossbar 30 is at its maximum vertical distance from the footers 12. This allows animal 26 to move under the lower crossbar 30 in some instances prior to initiation of measuring their height(s). In some embodiments, the automatic measuring wicket 100 is lifted off the ground and placed over a stationary animal 26 so as to contact the animal 26 at the desired measuring point (e.g., withers or hindquarters). Advantageously, the animal can move or be moved to change their measuring point (e.g., from their withers to their hindquarters) and the spring-biased lower crossbar 30 of automatic measuring wicket 100, with some counter urging of the user, will register continuous measurements of the animal 26 as it moves from measuring point one to measuring point two. Thus, the user is not required to recalibrate between the two measuring points as long as they maintain sufficient force so that the lower crossbar 30 contacts the animal 26.

Also, this continuous measuring functionality allows for continuous measurement readings of the profile of the animal 26 between the two measuring points, akin to plot points of a function. In some embodiments, the footers 12 may be replaced with rollers (not shown) so as to facilitate this continuous measuring functionality along the upper profile of the animal 26.

As used in this application, the term “about” or “approximately” refers to a range of values within plus or minus 10% of the specified number. And the term “substantially” refers to up to 80% or more of an entirety. Recitation of ranges of values herein are not intended to be limiting, referring instead individually to any and all values falling within the range, unless otherwise indicated, and each separate value within such a range is incorporated into the specification as if it were individually recited herein.

For purposes of this disclosure, the term “aligned” means parallel, substantially parallel, or forming an angle of less than 35.0 degrees. For purposes of this disclosure, the term “transverse” means perpendicular, substantially perpendicular, or forming an angle between 55.0 and 125.0 degrees. Also, for purposes of this disclosure, the term “length” means the longest dimension of an object. Also, for purposes of this disclosure, the term “width” means the dimension of an object from side to side. For the purposes of this disclosure, the term “above” generally means superjacent, substantially superjacent, or higher than another object although not directly overlying the object. Further, for purposes of this disclosure, the term “mechanical communication” generally refers to components being in direct physical contact with each other or being in indirect physical contact with each other where movement of one component affect the position of the other.

The use of any and all examples, or exemplary language (“e.g.,” “such as,” or the like) provided herein, is intended merely to better illuminate the embodiments and does not pose a limitation on the scope of the embodiments or the claims. No language in the specification should be construed as indicating any unclaimed element as essential to the practice of the disclosed embodiments.

In the following description, it is understood that terms such as “first,” “second,” “top,” “bottom,” “up,” “down,” and the like, are words of convenience and are not to be construed as limiting terms unless specifically stated to the contrary.

It should be understood, of course, that the foregoing relates to exemplary embodiments of the subject disclosure and that modifications may be made without departing from the spirit and scope of the subject disclosure as set forth in the following claims.

What is claimed is:

1. A measuring wicket comprising:
at least one leg portion, each leg portion having a proximal end configured to engage the supporting surface;
a crossbar assembly movable relative to the at least one leg portion between a resting point and a measuring point relative to the supporting surface;
a device that stores energy when compressed coupled to each leg portion and operatively associated with the crossbar assembly so as to bias the crossbar assembly toward the resting point relative to the supporting surface; and
measuring indicia provided along the leg portion so that a distance between the crossbar assembly and said proximal end is continuously visible.

2. The measuring wicket of claim 1, wherein the crossbar assembly has a slidable relationship with the at least one leg portion.

3. The measuring wicket of claim 1, wherein the crossbar assembly has at least one connector for each leg portion, wherein each connector slides over the leg portion.

4. The measuring wicket of claim 3, wherein the at least one leg portion is two leg portions.

5. The measuring wicket of claim 4, wherein the crossbar assembly spans between the two leg portions.

6. The measuring wicket of claim 5, wherein the crossbar assembly comprises an upper crossbar and a lower crossbar, wherein the lower crossbar contacts the measuring point.

7. The measuring wicket of claim 6, wherein said proximal end of each leg portion has a footer that contacts the supporting surface.

8. The measuring wicket of claim 7, further comprising a spring stop disposed within each leg portion, wherein each spring stop configured to limit compression of said device.

9. The measuring wicket of claim 7, wherein each leg portion is limited in travel by the footer at the proximal end thereof and by an end cap at a distal end thereof.

10. A method of continuously measuring two or more measuring points of an animal, the method comprising:
placing the measuring wicket of claim 1 over the animal until a proximal end of each leg portion contacts a supporting surface of the animal;
urging the crossbar assembly toward the animal until it contacts a first measuring point of the two or more measuring points;
moving the animal out of plane relative to said measuring wicket until the crossbar assembly contacts a second measuring point of the two or more measuring points while maintaining said urging of the crossbar assembly so that said distances, associated with the first and second measuring points, between the crossbar assembly and said proximal end measuring indicia are visible.
